(19) United States
(12) Patent Application Publication
(10) Pub. No.: US 2024/0354134 A1
(43) Pub. Date: Oct. 24, 2024

(54) FAULT RECOVERY METHOD AND APPARATUS FOR VIRTUALIZATION DEVICE

(71) Applicant: HANGZHOU ALICLOUD FEITIAN INFORMATION TECHNOLOGY CO., LTD., Hangzhou, Zhejiang (CN)

(72) Inventors: Shijun GONG, Hangzhou City (CN); Jintao LI, Beijing (CN)

(21) Appl. No.: 18/685,179

(22) PCT Filed: Oct. 26, 2022
(86) PCT No.: PCT/CN2022/127774

§ 371 Date: Feb. 20, 2024

(30) Foreign Application Priority Data
Dec. 31, 2021 (CN) 202111679753.6

(51) Int. Cl. G06F 9/455; G06F 11/14

(52) U.S. Cl. CPC G06F 9/45533; G06F 11/142

(57) ABSTRACT

The present application provides a method and apparatus for fault recovery of a virtualized device, an electronic device, and a machine-readable medium. According to embodiments of the present application, acquiring configuration information of the faulty virtualized device and status data of a data queue from a virtualized device synchronization module, if a virtual machine detects a fault of a virtualized device in a physical device; migrating the configuration information of the faulty virtualized device and the status data of the data queue to a new virtualized device by invoking a preset physical function driver, and performing a live migration on the virtual machine, such that the virtual machine communicates with the new virtualized device. In this case, the virtual machine can continue to process a service which is being processed originally, thereby ensuring that the service of the virtual machine is not interrupted, and achieving efficient recovery of the virtualized device.

### CROSS-REFERENCE TO RELATED APPLICATIONS

The present application claims the priority of Chinese Patent Application No. 202111679753.6, entitled “METHOD AND APPARATUS FOR FAULT RECOVERY OF VIRTUALIZED DEVICE”, filed with the China National Intellectual Property Administration on Dec. 31, 2021, which is incorporated in the present application by reference in its entirety.

### TECHNICAL FIELD

The present application relates to the technical field of computers and, in particular to a method for fault recovery of a virtualized device and an apparatus for fault recovery of a virtualized device.

### BACKGROUND

The Single Root I/O Virtualization (SR-IOV) protocol is an extension of the standard PCIe bus interconnection protocol. Its main goal is to present a single physical device as one physical function (PF) device and several virtual function (VF) devices by hardware virtualization of the I/O physical device itself. The Single Root I/O Virtualization protocol can serve a stand-alone computer system that supports direct I/O virtualization, and each virtual machine running on the system can directly own an independent physical device or virtualized device.

Generally, while the virtual machine is running, the virtual machine may run abnormally due to the fault of the virtualized device connected to it. In this case, because the virtualized device has no efficient way to recover from the fault, it is easy to cause the virtual machine to be in a fault state for a long time.

### SUMMARY

In view of the above problems, embodiments of the present application provide a method for fault recovery of a virtualized device and an apparatus for fault recovery of a virtualized device to overcome or at least partially solve the above problems.

In order to solve the above problems, the embodiments of the present application discloses a method for fault recovery of a virtualized device, including: acquiring configuration information of the faulty virtualized device and status data of a data queue from a virtualized device synchronization module, if a virtual machine detects a fault of the virtualized device in a physical device; migrating the configuration information of the faulty virtualized device and the status data of the data queue to a new virtualized device by invoking a preset physical function driver; and performing a live migration on the virtual machine, such that the virtual machine communicates with the new virtualized device.

The embodiments of the present application also provides an apparatus for fault recovery of a virtualized device, including: an acquisition module configured for acquiring configuration information of the faulty virtualized device and status data of a data queue from a virtualized device synchronization module, if a virtual machine detects a fault of the virtualized device in a physical device; a first mitigation module configured for migrating the configuration information of the faulty virtualized device and the status data of the data queue to a new virtualized device by invoking a preset physical function driver; and a second mitigation module configured for performing a live migration on the virtual machine, such that the virtual machine communicates with the new virtualized device.

The embodiments of the present application also disclose an electronic device, including: one or more processors; and one or more machine-readable media having instructions stored thereon that, when executed by one or more processors, cause the electronic device to perform the method of any one of the embodiments of the present application.

The embodiments of the present application also disclose one or more machine-readable media having instructions stored thereon that, when executed by one or more processors, cause the processors to perform the method of any one of the embodiments of the present application.

The above summary is for illustrative purpose only, and it is not intended to limit the present application in any way. In addition to the illustrative aspects, implementations and features described above, further aspects, implementations and features of the present application will be readily apparent with reference to the accompanying drawings and the following detailed description.

### BRIEF DESCRIPTION OF THE DRAWINGS

In the drawings, unless otherwise specified, the same reference numerals indicate the same or similar components or elements throughout the several drawings. These drawings are not necessarily drawn to scale. It should be understood that these drawings depict only some implementations according to the present disclosure and should not be deemed as limiting the scope of the present application.

FIG. 1 is a schematic diagram of a device according to an embodiment of the present application;

FIG. 2 is a flowchart of steps of an embodiment of a method for fault recovery of a virtualized device according to an embodiment of the present application;

FIG. 3 is a flowchart of steps of another embodiment of the method for fault recovery of the virtualized device according to an embodiment of the present application;

FIG. 4 is a schematic diagram of another device according to an embodiment of the present application;

FIG. 5 is a schematic diagram of another device according to an embodiment of the present application; and

FIG. 6 is a structural block diagram of an embodiment of an apparatus for fault recovery of a virtualized device according to an embodiment of the present application.

### DETAILED DESCRIPTION

In order to make the above objects, features and advantages of the present application more obvious and easier to understand, the present application will be further described in detail in conjunction with the accompanying drawings and the detailed description.

In embodiments of the present application, an I/O physical device can adopt the Single Root I/O Virtualization protocol, virtualize itself into one physical function (PF) device and several virtual function (VF) devices, and connect the virtual function (VF) devices with the virtual machines running in the server one by one. Among others, the physical function (PF) device can also be referred to physical function, and the virtual function (VF) device can also be referred to virtual function.

In the embodiments of the present application, by adding a virtualized device synchronization module to a virtual machine hypervisor, a function of synchronization of configuration information of the virtualized device and status data of a data queue is provided. When a virtual machine detects a fault of the virtualized device in a physical device, the configuration information of the virtualized device and the status data of the data queue can be acquired from the virtualized device synchronization module, so that the configuration information of the faulty virtualized device and the status data of the data queue can be migrated to a new virtualized device, and a live migration is performed on the virtual machine, such that the virtual machine communicates with the new virtualized device. The new virtualized device has the same configuration information and status data of the data queue as the faulty virtualized device, so that the virtual machine can communicate with the virtualized device in the original way, thereby realizing the rapid recovery from the virtualized device fault, and ensuring the normal running of the virtual machine.

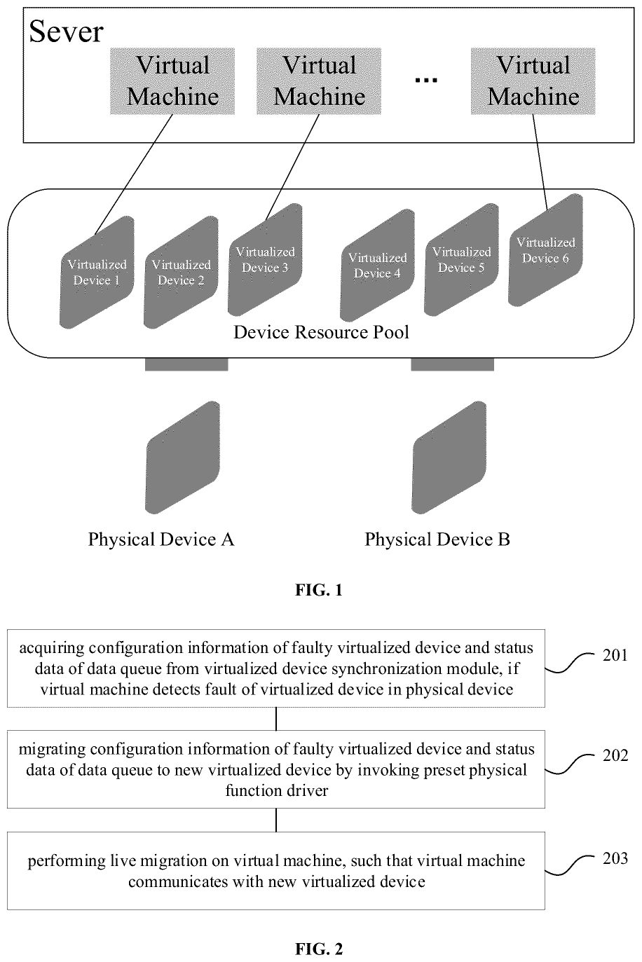

As an example of the present application, FIG. 1 is a schematic diagram of a device 100 according to an embodiment of the present application. It includes a server, a physical device A and a physical device B. Multiple virtual machines can run in the server. With I/O device virtualization technology, a virtualized device 1, a virtualized device 2 and a virtualized device 3 may run in the physical device A. A virtualized device 4, a virtualized device 5 and a virtualized device 6 may run in the physical device B. In order to make maximum use of the physical devices, the physical devices can be reconstructed by resource pooling to form a device resource pool including the virtualized devices 1, 2, 3, 4, 5 and 6. Each virtual machine in the server can be connected to one virtualized device, so that each virtual machine can have an independent I/O device.

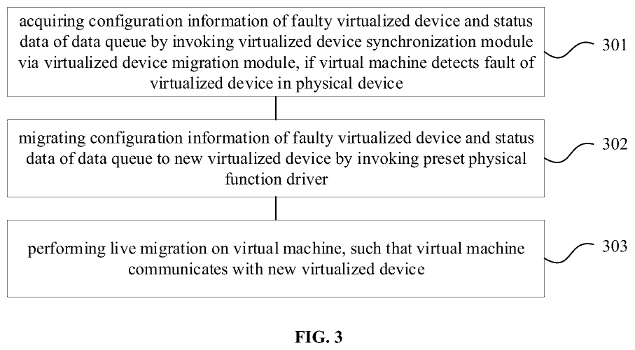

Referring to FIG. 2, a flowchart of steps of an embodiment of a method 200 for fault recovery of a virtualized device according to an embodiment of the present application is shown, which may specifically include the following steps 201 to 203.

In step 201, acquiring configuration information of the faulty virtualized device and status data of a data queue from a virtualized device synchronization module, if a virtual machine detects a fault of the virtualized device in a physical device.

When the virtualized device in the physical device fails, the physical device can generate an error report and prepare to provide services to the virtual machine for the fault interruption of the virtualized device. In this way, the virtual machine can detect that the virtualized device in the physical device fails.

In some implementations, in order to ensure the rapid recovery of the virtualized device when the virtualized device fails, a virtualized device synchronization module can be provided in the virtual machine hypervisor of the server. The virtualized device synchronization module can be used to synchronously acquire the configuration information of the virtualized device and the status data of the data queue. By acquiring the configuration information of the virtualized device and the status data of the data queue, the current running state of the virtualized device can be synchronized.

For example, the configuration information of the virtualized device may include interrupt configuration status (MSI-X), mapping configuration of Direct Memory Access (DMA), spatial mapping configuration of base address register (BAR), and configuration space and so on.

The data queue can be an actual data link used for data exchange. The status data of the data queue can include the base address of the data queue, the currently available id value (last_avail_idx), the currently used id value (last_used_idx) and so on.

Therefore, when the virtual machine detects the fault of the virtualized device in the physical device, the configuration information of the faulty virtualized device and the status data of the data queue can be acquired from the virtualized device synchronization module, so as to quickly recover the faulty virtualized device and ensure the normal running of the virtual machine.

In step 202, migrating the configuration information of the faulty virtualized device and the status data of the data queue to a new virtualized device by invoking a preset physical function driver.

In the embodiments of the present application, the physical function driver may be provided in the server. The physical function driver can be used to manage the physical devices, create the virtualized devices in the physical devices, set up the virtual machines to communicate with the virtualized devices, and configure the virtualized devices and so on.

Therefore, after the configuration information of the faulty virtualized device and the status data of the data queue of the faulty virtualized device is acquired, the configuration information of the faulty virtualized device and the status data of the data queue can be migrated to a new virtualized device by way of invoking the physical function driver, so that the new virtualized device can have the same running state as the faulty virtualized device.

In some implementations, there usually can be partially idle virtualized devices among the virtualized devices in the physical devices. Therefore, when the virtual machine detects that the virtualized device in the physical device fails, an idle virtualized device can be found as a new virtualized device in order to quickly recover from the fault of the virtualized device. It is also possible to create a new virtualized device by the physical function driver. Thereafter, the configuration information of the new virtualized device and the status data of the data queue can be set to be the same as the faulty virtualized device, so as to complete the migration of the configuration information of the faulty virtualized device and the status data of the data queue.

In step 203, performing a live migration on the virtual machine, such that the virtual machine communicates with the new virtualized device.

After the configuration information of the faulty virtualized device and the status data of the data queue to the new virtualized device is migrated, a live migration is performed on the virtual machine, such that the virtual machine changes from communicating with the faulty virtualized device to communicating with the new virtualized device. Thus, the virtual machine can communicate with a normally running virtualized device to ensure its normal running. At the same time, the new virtualized device has the configuration information of the faulty virtualized device and the status data of the data queue and can run in the same running state as the faulty virtualized device. The virtual machine can continue to process a service which is being processed originally by communicating with the new virtualized device, thereby ensuring that the service of the virtual machine is not interrupted.

With the method for fault recovery of the virtualized device provided by the embodiment of the present application, acquiring configuration information of the faulty virtualized device and status data of a data queue from a virtualized device synchronization module, if a virtual machine detects a fault of a virtualized device in a physical device; migrating the configuration information of the faulty virtualized device and the status data of the data queue to a new virtualized device by invoking a preset physical function driver, so that the new virtualized device can have the same running state as the faulty virtualized device; and thereafter, performing a live migration on the virtual machine, such that the virtual machine communicates with the new virtualized device. In this case, the virtual machine can continue to process a service which is being processed originally, thereby ensuring that the service of the virtual machine is not interrupted, and achieving efficient recovery of the virtualized device.

Referring to FIG. 3, a flowchart of steps of another embodiment of a method 300 for fault recovery of another virtualized device according to an embodiment of the present application is shown, which may specifically include the following steps 301 to 303.

In step 301, acquiring configuration information of the faulty virtualized device and status data of a data queue by invoking a virtualized device synchronization module via a virtualized device migration module, if a virtual machine detects a fault of a virtualized device in a physical device.

When the virtualized device in the physical device fails, the physical device can generate an error report and prepare to provide services to the virtual machine for the fault interruption of the virtualized device. In this way, the virtual machine can detect that the virtualized device in the physical device fails.

In some implementations, in order to ensure the rapid recovery of the virtualized device when the virtualized device fails, a virtualized device synchronization module can be provided in the virtual machine hypervisor of the server. The virtualized device synchronization module can be used to synchronously acquire the configuration information of the virtualized device and the status data of the data queue. By acquiring the configuration information of the virtualized device and the status data of the data queue, the current running state of the virtualized device can be synchronized. At the same time, in order to manage the migration of virtualized devices, a virtualized device migration module can be provided in the virtual machine hypervisor of the server.

Thus, when the virtual machine detects a fault of a virtualized device in a physical device, the virtual machine can invoke the virtualized device migration module to start the migration process. In order to complete the fault recovery of the virtualized device, the configuration information of the faulty virtualized device and the status data of the data queue can be first acquired from a virtualized device synchronization module, so as to quickly recover the faulty virtualized device and ensure the normal running of the virtual machine.

In some implementations, the above method further includes: S11, storing the configuration information of the virtualized device and the status data of the data queue, if the virtual machine establishes a connection with the virtualized device in the physical device.

For example, when a virtualized device in a physical device is assigned to a virtual machine, and a connection is established between the virtual machine and the virtualized device, the virtual machine can request to store configuration information of the virtualized device and status data of a data queue, so as to back up the running state of the virtualized device.

In some implementations, the step of storing the configuration information of the virtualized device and the status data of the data queue, if the virtual machine establishes the connection with the virtualized device in the physical device, includes: S21, storing the configuration information of the virtualized device by the virtualized device synchronization module, if the virtual machine establishes the connection with the virtualized device in the physical device.

For example, when the virtual machine establishes a connection with the virtualized device in the physical device, a request can be made to store the original configuration information of the virtualized device by the virtualized device synchronization module, so as to back up the running state of the virtualized device from the time when the virtual machine establishes a connection with the virtualized device in the physical device.

For example, the virtual machine can start the process of synchronization of the virtualized device by invoking the virtualized device migration module. Thereafter, the virtualized device migration module can acquire the configuration information of the virtualized device from the virtualized device and store it in the virtualized device synchronization module.

In some implementations, the above method further includes: S31, synchronously updating the configuration information of the virtualized device and synchronously storing the status data of the data queue by the virtualized device synchronization module, during the communication between the virtual machine and the virtualized device.

For example, during the communication between the virtual machine and the virtualized device, the configuration information of the virtualized device can be synchronously updated in real time by the virtualized device synchronization module, and the status data of the data queue can be synchronously stored in real time, so that when the virtualized device fails, the virtualized device can be recovered to the latest state in time, and the virtual machine can continue to run normally.

For example, a physical function driver may be provided in the server. The physical function driver can be used to manage the physical devices, create the virtualized devices in the physical devices, set up the virtual machines to communicate with the virtualized devices, and configure the virtualized devices.

Therefore, the virtualized device synchronization module can acquire the configuration information of the virtualized device and the status data of the data queue in real time by the physical function driver and realize synchronous updating of the configuration information of the virtualized device and the status data of the data queue.

In some implementations, the above method further includes: S41, configuring a preset error reporting function of the physical device to stop sending out an error report.

For example, a physical device can originally have a preset error reporting function, and when the physical device fails, the physical device can send out an error report to request an external device such as a central processing unit (CPU) to repair the errors existing in the physical device. The error reporting function can also be used in the fault recovery of the virtualized device. However, if the preset error reporting function is used to request external devices to recover the virtualized device, it may take a longer time, resulting in that the virtual machine cannot run normally for a long time. Alternatively, the error occurred in the virtualized device may be irreparable, so sending out an error report may not help the virtualized device to resume normal running at this time.

Therefore, before the method for fault recovery of the virtualized device of the present application is adopted to ensure that the virtual machine can run normally, the preset error reporting function of the physical device can be configured to stop sending out the error report. Thus, when the virtual machine fails, it is not necessary to send out an error report in the original way, but the virtualized device can be quickly recovered by the method for fault recovery of the virtualized device of the present application.

For example, the error reporting function of a physical device can be an Advanced Error Reporting (AER) function or a Deferred Procedure Call (DPC) function. The Advanced Error Reporting function can be configured to prohibit sending out the error report. At this time, the error reporting function can use non-posted requests, and return the completion status with errors for the unsent requests, thus avoiding the use of the original error reporting function to send out the error report. At the same time, it is also possible to avoid possible system downtime caused by physical device fault.

In step 302, migrating the configuration information of the faulty virtualized device and the status data of the data queue to a new virtualized device by invoking a preset physical function driver.

After acquiring the configuration information of the faulty virtualized device and the status data of the data queue, the configuration information of the faulty virtualized device and the status data of the data queue can be migrated to a new virtualized device by way of invoking the physical function driver, so that the new virtualized device can have the same running state as the faulty virtualized device.

In some implementations, there usually can be partially idle virtualized devices among the virtualized devices in the physical devices. Therefore, when the virtual machine detects that the virtualized device in the physical device fails, an idle virtualized device can be found as a new virtualized device in order to quickly recover from the fault of the virtualized device. It is also possible to create a new virtualized device by the physical function driver. Thereafter, the configuration information of the new virtualized device and the status data of the data queue can be set to be the same as the faulty virtualized device, so as to complete the migration of the configuration information of the faulty virtualized device and the status data of the data queue.

In step 303, performing a live migration on the virtual machine, such that the virtual machine communicates with the new virtualized device.

After the configuration information of the faulty virtualized device and the status data of the data queue to the new virtualized device is migrated, a live migration is performed on the virtual machine, such that the virtual machine changes from communicating with the faulty virtualized device to communicating with the new virtualized device. Thus, the virtual machine can communicate with the normally running virtualized device to ensure its normal running. At the same time, the new virtualized device has the configuration information of the faulty virtualized device and the status data of the data queue, and can run in the same running state as the faulty virtualized device. The virtual machine can continue to process a service which is being processed originally by communicating with the new virtualized device, thereby ensuring that the service of the virtual machine is not interrupted.

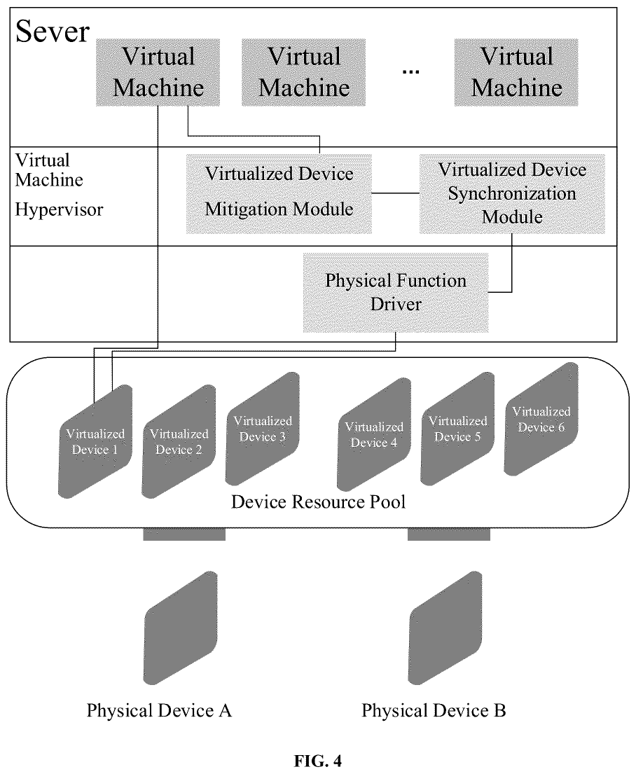

As a specific example of the present application, FIG. 4 is a schematic diagram of an apparatus 400 of the present application.

When a connection is established between a virtual machine and a virtualized device 1, the virtual machine sends its acquired configuration information of the virtualized device 1 to a virtualized device migration module. The virtualized device migration module can store the configuration information of the virtualized device 1 in a virtualized device synchronization module. Thereafter, during the communication between the virtual machine and the virtualized device 1, the virtualized device synchronization module can acquire the configuration information of the virtualized device 1 and state information of a data queue in real time by a physical function driver, and synchronously store them, thus realizing the real-time storage of the configuration information of the virtualized device 1 and the state information of the data queue.

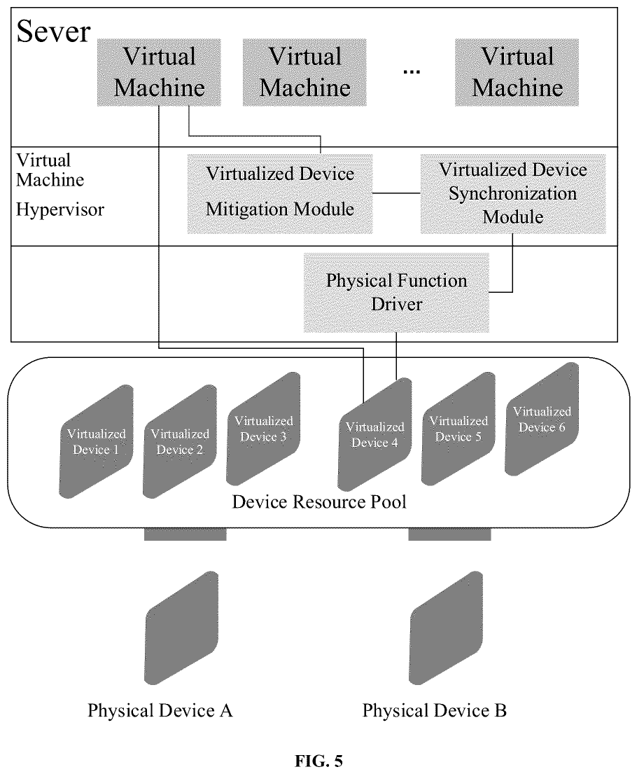

As a specific example of the present application, FIG. 5 is a schematic diagram of another device 500 of the present application.

During the communication between the virtual machine and the virtualized device 1, if the virtual machine detects that the virtualized device 1 fails, the virtual machine can inform the virtualized device migration module the fault. The virtualized device migration module can acquire the configuration information of the faulty virtualized device 1 and the status data of the data queue by the virtualized device synchronization module, and thereafter, send the configuration information of the faulty virtualized device 1 and the status data of the data queue to the physical function driver. The physical function driver will migrate the configuration information of the faulty virtualized device 1 and the status data of the data queue to the new virtualized device 4. In this case, the new virtualized device 4 can have the same running state as the faulty virtualized device 1. After that, a live migration is performed on the virtual machine, such that the virtual machine communicates with the new virtualized device 4. The virtual machine then can provide services based on the new virtualized device 4 to ensure the normal running of the virtual machine.

With the method for fault recovery of a virtualized device provided by the embodiment of the present application, when a virtual machine detects a fault of a virtualized device in a physical device, configuration information of the faulty virtualized device and status data of a data queue is acquired by invoking a virtualized device synchronization module via a virtualized device migration module; the configuration information of the faulty virtualized device and the status data of the data queue to a new virtualized device is migrated by invoking a preset physical function driver, so that the new virtualized device can have the same running state as the faulty virtualized device; and thereafter, a live migration is performed on the virtual machine, such that the virtual machine communicates with the new virtualized device. In this case, the virtual machine can continue to process a service which is being processed originally, thereby ensuring that the service of the virtual machine is not interrupted, and achieving efficient recovery of the virtualized device.

It should be noted that for the sake of simple description, the method embodiments are all expressed as a combination of a series of actions, but it is acknowledged by those skilled in the art that the embodiments of the present application are not limited by the sequence of the described actions, because some steps can be performed in alternative sequences or be performed simultaneously according to the embodiments of the present application. Secondly, those skilled in the art should also know that the embodiments described in the specification are all preferred embodiments, and the actions involved may be not necessary for the embodiments of the present application.

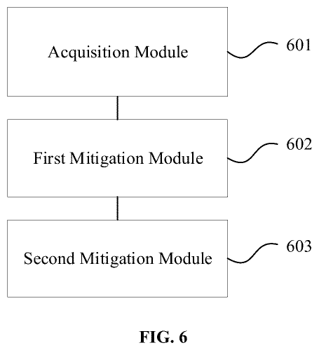

Referring to FIG. 6, a structural block diagram of an embodiment of an apparatus 600 for fault recovery of another virtualized device according to an embodiment of the present application is shown, which may specifically include the following modules: an acquisition module 601 configured for acquiring configuration information of the faulty virtualized device and status data of a data queue from a virtualized device synchronization module, if a virtual machine detects a fault of a virtualized device in a physical device; a first mitigation module 602 configured for migrating the configuration information of the faulty virtualized device and the status data of the data queue to a new virtualized device by invoking preset physical function driver; and a second mitigation module 603 configured for performing a live migration on the virtual machine, such that the virtual machine communicates with the new virtualized device.

In some implementations, the acquisition module 601 may include: an acquisition submodule configured for acquiring the configuration information of the faulty virtualized device and the status data of the data queue by invoking the virtualized device synchronization module via a virtualized device migration module, if the virtual machine detects the fault of the virtualized device in the physical device.

In some implementations, the above apparatus may further include: a data storage module configured for storing the configuration information of the virtualized device and the status data of the data queue, if the virtual machine establishes a connection with the virtualized device in the physical device.

In some implementations, the above data storage module may include: a configuration storage submodule configured for, storing the configuration information of the virtualized device by the virtualized device synchronization module, if the virtual machine establishes the connection with the virtualized device in the physical device.

In some implementations, the above apparatus may further includes: a synchronization submodule configured for synchronously updating the configuration information of the virtualized device and synchronously storing the status data of the data queue by the virtualized device synchronization module, during the communication between the virtual machine and the virtualized device.

In some implementations, the apparatus may further include: a function configuration module configured for configuring a preset error reporting function of the physical device to stop sending out an error report.

For the apparatus embodiments, because they are basically similar to the method embodiments, the description thereof is relatively simple, and for relevant portions, reference may be made to a portion of the description of the method embodiments.

The embodiments of the present application also provide an electronic device, including: one or more processors; and one or more machine-readable media having instructions stored thereon that, when executed by one or more processors, cause the electronic device to perform the method of the embodiments of the present application.

The embodiments of the present application also provide one or more machine-readable media having instructions stored thereon that, when executed by one or more processors, cause the processors to perform the method of the embodiments of the present application.

With the method for fault recovery of a virtualized device provided by the embodiments of the present application, when a virtual machine detects a fault of a virtualized device in a physical device, configuration information of the faulty virtualized device and status data of a data queue is acquired from a virtualized device synchronization module; the configuration information of the faulty virtualized device and the status data of the data queue to a new virtualized device is migrated by invoking a preset physical function driver, so that the new virtualized device can have the same running state as the faulty virtualized device; and thereafter, a live migration is performed on the virtual machine, such that the virtual machine communicates with the new virtualized device. In this case, the virtual machine can continue to process a service which is being processed originally, thereby ensuring that the service of the virtual machine is not interrupted, and achieving efficient recovery of the virtualized device.

Each embodiment in the present application is described in a progressive way, and each embodiment focuses on the differences from other embodiments, so for the same or similar parts between the embodiments, the embodiments can refer to each other.

It should be appreciated by those skilled in the art that the embodiments of the present application can be provided as a method, an apparatus, or a computer program product. Therefore, embodiments of the present application may take the form of an entirely hardware embodiment, an entirely software embodiment, or an embodiment combining software and hardware aspects. Furthermore, the embodiments of the present application may take the form of computer program products implemented on one or more computer-usable storage media (including but not limited to disk storage, CD-ROM, optical storage, etc.) containing computer-usable program codes therein.

The embodiments of the present application are described with reference to flowcharts and/or block diagrams of methods, terminal devices (systems), and computer program products according to embodiments of the present application. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, a special-purpose computer, an embedded processor or other programmable data processing terminal device to produce a machine, such that the instructions which are executed by the processor of the computer or other programmable data processing terminal device produce means for implementing the functions specified in one or more flows in the flowchart and/or one or more blocks in the block diagram.

These computer program instructions can also be stored in a computer-readable memory that can direct a computer or other programmable data processing terminal device to operate in a specific manner, so that the instructions stored in the computer-readable memory produce an article of manufacture including instruction means that implement the functions specified in one or more flows in the flowchart and/or one or more blocks in the block diagram.

These computer program instructions can also be loaded on a computer or other programmable data processing terminal device, so that a series of operation steps are performed on the computer or other programmable terminal device to produce computer-implemented processes, so that the instructions executed on the computer or other programmable terminal device provide steps for implementing the functions specified in one or more flows in the flowchart and/or one or more blocks in the block diagram.

Although the preferred embodiments of the embodiments of the present application have been described, those skilled in the art can make additional changes and modifications to these embodiments once they know the basic inventive concepts. Therefore, the appended claims are intended to be interpreted as including the preferred embodiments and all changes and modifications that fall within the scope of the embodiments of the present application.

Finally, it should be noted that relational terms herein such as first and second are only used to distinguish one entity or operation from another entity or operation, and do not necessarily require or imply any such actual relationship or order between these entities or operations. Moreover, the terms “comprising”, “including”, “containing” or any other variations thereof are intended to cover non-exclusive inclusion, so that a process, method, article, or terminal device including a series of elements includes not only those elements, but also other elements not explicitly listed, or elements inherent to such process, method, article, or terminal device. Without more restrictions, the element defined by the phrase “including one . . . ” does not exclude that there are other identical elements in the process, method, article, or terminal device including the element.

A method for fault recovery of a virtualized device and an apparatus for fault recovery of a virtualized device provided by the present application are described in detail above. The principle and implementation of the present application are stated herein with specific examples, and the description of the above embodiments is only used to help understand the method and core idea of the present application. At the same time, according to the idea of the present application, there will be changes in the specific implementation and application scope for those skilled in the art. To sum up, the contents of this specification should not be understood as limitations to the present application.

1. A method for fault recovery of a virtualized device, comprising:
acquiring configuration information of a faulty-virtualized device and status data of a data queue from a virtualized device synchronization module upon detection of a fault, by a virtual machine, of the virtualized device in a physical device;
migrating the configuration information of the virtualized device and the status data of the data queue to a new virtualized device by invoking a preset physical function driver; and
performing a live migration on the virtual machine, such that the virtual machine communicates with the new virtualized device.

2. The method of claim 1, wherein the step of acquiring the configuration information of the virtualized device and the status data of the data queue from the virtualized device synchronization module upon detection of the fault, by the virtual machine, of the virtualized device in the physical device, comprises:
acquiring the configuration information of the virtualized device and the status data of the data queue by invoking the virtualized device synchronization module via a virtualized device migration module upon detection of the fault, by the virtual machine, of the virtualized device in the physical device.

3. The method of claim 1, further comprising:
storing the configuration information of the virtualized device and the status data of the data queue when the virtual machine establishes a connection with the virtualized device in the physical device.

4. The method of claim 3, wherein the step of storing the configuration information of the virtualized device and the status data of the data queue when the virtual machine establishes the connection with the virtualized device in the physical device, comprises:
storing the configuration information of the virtualized device by the virtualized device synchronization module when the virtual machine establishes the connection with the virtualized device in the physical device.

5. The method of claim 1, further comprising:
synchronously updating the configuration information of the virtualized device and synchronously storing the status data of the data queue by the virtualized device synchronization module, during one or more communications between the virtual machine and the virtualized device.

6. The method of claim 1, further comprising:
configuring a preset error reporting function of the physical device to stop sending out an error report.

7. An apparatus for fault recovery of a virtualized device, comprising:
an acquisition module configured for acquiring configuration information of a virtualized device and status data of a data queue from a virtualized device synchronization module upon detection of a fault, by a virtual machine, of the virtualized device in a physical device;
a first mitigation module configured for migrating the configuration information of the virtualized device and the status data of the data queue to a new virtualized device by invoking a preset physical function driver; and
a second mitigation module configured for performing a live migration on the virtual machine, such that the virtual machine communicates with the new virtualized device.

8. The apparatus of claim 7, wherein the acquisition module comprises:
an acquisition submodule configured for acquiring the configuration information of the virtualized device and the status data of the data queue by invoking the virtualized device synchronization module via a virtualized device migration module upon detection of the fault, by the virtual machine.

9. An electronic device, comprising:
one or more processors; and
one or more machine-readable media having instructions stored thereon that, when executed by the one or more processors, cause the electronic device to perform the method of claim 1.

10. An electronic device, comprising:
one or more processors; and
one or more machine-readable media having instructions stored thereon that, when executed by the one or more processors, cause the electronic device to perform the method of claim 2.

11. An electronic device, comprising:
one or more processors; and
one or more machine-readable media having instructions stored thereon that, when executed by the one or more processors, cause the electronic device to perform the method of claim 3.

12. An electronic device, comprising:
one or more processors; and
one or more machine-readable media having instructions stored thereon that, when executed by the one or more processors, cause the electronic device to perform the method of claim 4.

13. An electronic device, comprising:
one or more processors; and
one or more machine-readable media having instructions stored thereon that, when executed by the one or more processors, cause the electronic device to perform the method of claim 5.

14. An electronic device, comprising:
one or more processors; and
one or more machine-readable media having instructions stored thereon that, when executed by the one or more processors, cause the electronic device to perform the method of claim 6.

15. One or more machine-readable media having instructions stored thereon that, when executed by one or more processors, cause the processors to perform the method of claim 1.

16. One or more machine-readable media having instructions stored thereon that, when executed by one or more processors, cause the processors to perform the method of claim 2.

17. One or more machine-readable media having instructions stored thereon that, when executed by one or more processors, cause the processors to perform the method of claim 3.

18. One or more machine-readable media having instructions stored thereon that, when executed by one or more processors, cause the processors to perform the method of claim 4.

19. One or more machine-readable media having instructions stored thereon that, when executed by one or more processors, cause the processors to perform the method of claim 5.

20. One or more machine-readable media having instructions stored thereon that, when executed by one or more processors, cause the processors to perform the method of claim 6.
